(19) United States
(12) Patent Application Publication
(10) Pub. No.: US 2017/0199906 A1
(43) Pub. Date: Jul. 13, 2017

(54) SYSTEM AND METHOD FOR CONTENT-QUALITY SCORING

(71) Applicant: Verint Americas Inc., Alpharetta, GA (US)

(72) Inventors: Jose Lema, Antioch, CA (US); Wyatt Lyon Preul, Kansas City, MO (US); Stacy Randolph, Bothell, WA (US)

(21) Appl. No.: 15/407,706

(22) Filed: Jan. 17, 2017

Related U.S. Application Data
(63) Continuation of application No. 14/202,597, filed on Mar. 10, 2014.
(60) Provisional application No. 61/775,261, filed on Mar. 8, 2013.

(51) Int. Cl. G06F 17/30

(52) U.S. Cl. CPC G06F 17/30321; G06F 17/3053

(57) ABSTRACT

A method for content-quality scoring, the method comprising obtaining a plurality of metrics associated with a piece of content on an online community, weighing the plurality of metrics resulting in an weighted value for the plurality of metrics, applying a decay to the weighted value for the plurality of metrics resulting in a decayed value for the plurality of metrics, and calculating a content-quality score for the piece of content using at least one of the plurality of metrics, the weighted value for the plurality of metrics and the decayed value for the plurality of metrics.

### RELATED APPLICATIONS

This application is a continuation of U.S. Utility Application No. 14/202,597, filed on Mar. 10, 2014, entitled “System and Method for Content-Quality Scoring”, which claims priority to U.S. Provisional Application No. 61/775,261, filed on Mar. 8, 2013, the disclosures of which are incorporated by reference in their entireties. This application also incorporates by reference the entire disclosure of U.S. patent application Ser. No. 13/166,760, filed on Jun. 22, 2011 and entitled “System and Method for Analyzing Users of an Online Community.”

### FIELD OF THE INVENTION

The present disclosure relates generally to analytics and more specifically, but not by way of limitation, to systems and methods for content-quality scoring.

### BACKGROUND

User interaction with cloud-based content has been increasing for many years. The value of content has long exceeded the value of the machines and systems that store the content. Realization of the value, however, generally depends on an extent to which valuable content can be identified and made accessible to users. Therefore, there is an ongoing need to improve how content is analyzed and accessed.

### SUMMARY OF THE INVENTION

In one embodiment, a method for content-quality scoring includes obtaining a plurality of metrics associated with a piece of content on an online community. The method further includes weighing the plurality of metrics. The weighing yields a plurality of weighted values. The method also includes applying a decay to the plurality of weighted values. The applying yields a plurality of decayed values. Further, the method includes calculating a content-quality score for the piece of content based, at least in part, on the plurality of decayed values.

In one embodiment, a system includes a processing unit, wherein the processing unit is operable to implement a method. The method includes obtaining a plurality of metrics associated with a piece of content on an online community. The method further includes weighing the plurality of metrics. The weighing yields a plurality of weighted values. The method also includes applying a decay to the plurality of weighted values. The applying yields a plurality of decayed values. Further, the method includes calculating a content-quality score for the piece of content based, at least in part, on the plurality of decayed values.

In one embodiment, a computer-program product includes a non-transitory computer-usable medium having computer-readable program code embodied therein. The computer-readable program code is adapted to be executed to implement a method. The method includes obtaining a plurality of metrics associated with a piece of content on an online community The method further includes weighing the plurality of metrics. The weighing yields a plurality of weighted values. The method also includes applying a decay to the plurality of weighted values. The applying yields a plurality of decayed values. Further, the method includes calculating a content-quality score for the piece of content based, at least in part, on the plurality of decayed values.

### BRIEF DESCRIPTION OF THE DRAWINGS

A more complete understanding of the system and method of the present invention may be obtained by reference to the following Detailed Description when taken in conjunction with the accompanying Drawings wherein:

FIG. 1A is a schematic diagram illustrating an exemplary system for an online community according to an embodiment of the present invention.

FIG. 1B is a schematic diagram illustrating a community computer system according to an embodiment of the present invention.

FIG. 2 illustrates an example of a process for content-quality scoring.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

In various embodiments, content quality may be more effectively scored via systems and methods described herein. In a typical embodiment, the more effective content-quality scoring may also facilitate improved content searching. As used herein, an online community, often called a social network, may be considered a collection of people or organizations with a common set of interests that come together over a computer network and interact through a set of collaboration tools. The people or organizations that come together via an online community are referred to herein as users.

For purposes of this patent application, collaboration tools refer to software in an online community that facilitates interaction or sharing of information among users. Collaboration tools may enable, for example, user profiles, blogs, discussion forums, wikis, comments, ratings, and other tools. Content, often referred to herein as a piece of content (POC), may refer to a segment of information that is treated as a unit, for example, in an online community. Content may include, for example, particular blog entries, discussion forums, wikis, comments, or the like.

Actions taken by users of an online community via collaboration tools are referred to herein as behaviors. Behaviors may include, for example, generating a wiki post or a blog post, initiating a thread in a discussion forum, commenting to a wiki post or a blog post, replying to a post in a discussion forum, adding another user as a friend, and the like. Behaviors may also include, for example, rating, bookmarking, indicating an affinity for (e.g. “liking”), or subscribing to content. A connection, as used herein, may result from behaviors by users that link one user to another user. For example, connections may be created between users by one user adding another user as a “friend” in an online community.

As one of ordinary skill in the art will appreciate, online communities may exist to serve a variety of different purposes. For example, an online support community is generally a community that may provide assistance with products such as, for example, mobile phones, televisions, computers, software products, or electronic and mechanical goods. An online support community may include, for example, forums in which users may ask and answer questions. The assistance provided on an online support community may include, for example, assistance with specific problems with a product, assistance with customization, training services, or other support services. The assistance is generally provided by users of the online support community, which may include, for example, employees of a particular organization associated with the product (e.g., a manufactures of the product) or non-employee users that are knowledgeable about the product.

As one of ordinary skill in the art will appreciate, depending on how and by whom an online community is managed, organizations may have varying degrees of control over content. For example, a managed community is typically a community that an organization creates and manages itself for its users, fans, or customers or for internal use by its employees. By way of further example, a participant community is typically a community that is publicly managed and provides public community-building tools for use by organizations (e.g., Facebook and Twitter). In a participant community, organizations may use the public community-building tools to create sub-communities that the organizations can manage but do not necessarily own. Another example of a community type is an observer community. An observer community is typically a community that is created and actively managed by customers for a particular organization. The particular organization often may be allowed to participate in the observer community but generally has no control over content in the observer community.

In various embodiments, an analytics system is provided that more effectively and efficiently manages users and content on an online community by monitoring and recording behaviors of users and generating analytics based on the behaviors. In various embodiments, the analytics system is operable to perform content-quality scoring. Content-quality scoring will be described in greater detail below.

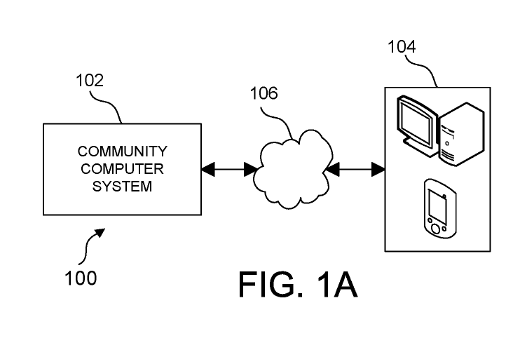

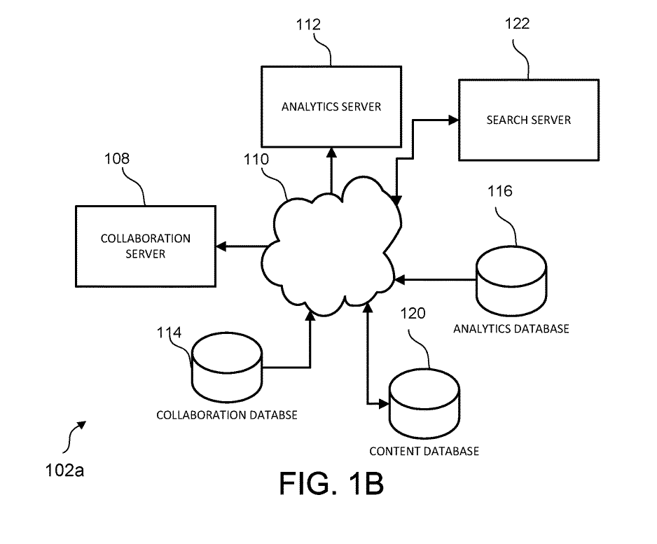

Referring now to FIG. 1A, a schematic diagram illustrating an exemplary system 100 for an online community according to an embodiment of the present invention is disclosed. The system 100 for the online community may comprise a community computer system 102, a network 106, and a plurality of computing devices 104. In a typical embodiment, the community computer system 102 may be operable to provide collaboration tools over the network 106 to users operating the plurality of computing devices 104. The plurality of computing devices 104 may include, for example, desktop computers, mobile phones, tablet computers, laptop computers, personal digital assistants (PDAs), and the like. The network 106 may be any type of computer network including, for example, a corporate intranet or the Internet. The system 100 may be, for example, for an online support community for a software product.

The community computer system 102 may typically facilitate interaction among users of the online community via the collaboration tools. In a typical embodiment, the community computer system 102 may monitor and record behaviors of users. The community computer system 102 is typically further operable to generate analytics related to, for example, users, discussion topics, and the like. The generated analytics may be provided over the network 106 to administrators or authorized users via a report or dashboard interface.

Referring now to FIG. 1B, a schematic diagram illustrating a community computer system 102a according to an embodiment of the present invention is disclosed. The community computer system 102a may be an exemplary embodiment of the community computer system 102 of FIG. 1A. The community computer system 102a may be a distributed system that may distribute community functionality among a collaboration server 108, an analytics server 112, a search server 122, one or more collaboration databases 114, one or more analytics databases 116, and one or more content databases 120. In various embodiments in which, for example, an online community is a managed community as described above, the community computer system 102a may reside at an organization's physical premises. As shown, the collaboration server 108, the analytics server 112, the search server 122, the one or more collaboration databases 114, the one or more analytics databases 116, and the one or more content databases 120 may be operable to communicate over a network 110. The network 110 may be, for example, a public or private intranet.

In various embodiments, the collaboration server 108 may provide collaboration tools over a computer network such as, for example, the network 106 of FIG. 1A, and thereby facilitate interaction among users. In a typical embodiment, the collaboration server 108 may manage the one or more collaboration databases 114. The collaboration server 108 typically records, inter alia, behaviors of users in the one or more collaboration databases 114. In addition, the collaboration server 108 may typically result in content being created and stored in the one or more content databases 120.

The analytics server 112 may typically direct the generation of analytics for the online community. In a typical embodiment, the analytics server 112 may manage the one or more analytics databases 116 and may record generated analytics therein. The generation of analytics may comprise, for example, generation of content-quality scores (CQSs). Exemplary generation of CQSs will be described in greater detail below.

In a typical embodiment, the search server 122 may maintain a search index of content stored by the one or more content databases 120. The search server 122 may be operable to search the search index based on, for example, search criteria entered by a user. The search server 122 may then generate and provide search results from the one or more content databases 120 to the user. The search server 122 may utilize, for example, a platform based on Apache Solr. In a typical embodiment, as described in greater detail below, search indexing can be influenced by CQSs generated by the analytics server 112.

For purposes of illustration, various computers or computer systems are illustrated in FIG. 1B such as, for example, the collaboration server 108, the analytics server 112, and the search server 122. One of ordinary skill in the art will appreciate that each instance of a computer or computer system may, in various embodiments, represent either a physical server computer or a virtual server computer. Likewise, although various server computers are illustrated in FIG. 1B, in various embodiments, more or fewer server computers (physical or virtual) may be utilized, for example, in order to scale functionality described herein for specific online communities that may vary in size and in an amount of network traffic generated. Thus, one of ordinary skill in the art will appreciate that the community computer system 102a is exemplary in nature and that more or fewer physical or virtual server computers may be utilized to accomplish similar results. Similarly, for purposes of illustration, various databases are illustrated in FIG. 1B such as, for example, the one or more collaboration databases 114, the one or more analytics databases 116, and the one or more content databases 120. Although various databases are illustrated separately in FIG. 1B, in various embodiments, more or fewer databases may be utilized.

An exemplary content-quality scoring algorithm that may be implemented by an analytics server such as, for example, the analytics server 112 of FIG. 1B, will now be described. A CQS may be, for example, a normalized value assigned to a POC that may be derived from a set of weighted explicit and implicit quality metrics with decay applied. It should be appreciated that the CQS is generally a relative score. That is, the score may be useful for comparison against other POCs (higher is better), but the actual value of the score itself is not necessarily meaningful.

In a typical embodiment, whenever the CQS is recalculated for a POC, the POC may be re-indexed by a search server (e.g., the search server 122 of FIG. 1B) in order to give a relative “boost” to the POC in the search index. The boost may be applied as a multiplier on the relevancy score and can equal, for example, the CQS+1. In a typical embodiment, the boost may guarantee that, all things being equal, when two POCs are returned by a search engine, the POC with a higher CQS may be returned first.

In a typical embodiment, basic inputs to the CQS are metrics. Metrics may be small pieces of code (e.g., plugins in the community computer system) that may be calculated by taking a specific type of user behavior with respect to a POC and computing a normalized value. In some embodiments, the metrics may be, for example, simple constants. In some embodiments, the metrics may be more complex. For example, in various embodiments, the CQS may be based on twelve distinct metrics. In various other embodiments, the CQS may be configurable. For example, users may choose to remove existing metrics and/or add custom metrics for their specific implementation.

In various other embodiments, all metrics in the CQS may be given the same relative importance by default. As such, they would all have the same weight. Users, however, may choose which metrics are more (or less) important, for example, by using sliders in a user interface (e.g., an administrative control panel). In various embodiments, since the CQS may be particularly useful for search ranking, weights may configurable at a site level.

Another component of the CQS is decay. In a typical embodiment, decay may slowly reduce the CQS for a POC over time. This may guarantee that newer content may have a higher CQS than older content. An exemplary calculation method for decay may be half-life based. For example, in various embodiments, decay may be enabled by default and the half-life for the CQS may be set to 30 days (i.e. decay interval). This means that every30 days a POC's CQS may be recalculated and reduced by half its current value. In a typical embodiment, not only may the half-life be changed at the site level, but individual applications (blogs, forums, galleries, etc.) may override the decay interval.

In various embodiments, whenever any configurable portion of the CQS is changed, the value for all POCs may be recalculated. Furthermore, whenever individual metric values change, the CQS for the related POC may be recalculated. Equation 1 below is an example of an embodiment of how a CQS may be formalized:

$$CQS = \frac{Decay {\sum }_{i = 1}^{n} ( {Weight}_{i} ⋆ {Value}_{i} )}{{\sum }_{i = 1}^{n} {Weight}_{i}} \qquad Equation 1$$

Various embodiments of metrics will now be described. Metrics may comprise, but are not limited to, a comments metric, a downloads metric, a bookmarks metric, a featured metric, a forum reply count metric, a likes metric, a ratings metric, a suggested answer metric, a tags metric, a user subscriptions metric, a verified answer metric, and a views metric.

The comments metric may be a normalized value which may measure the number of comments for a POC. A threshold for comments may be set to a predetermined value such as, for example, 50. That is, a POC with 50 comments may receive the same metric value as a POC with 100 comments. To calculate the comments metric value, take a number of comments divided by 50 and cap the value at 1. In an embodiment, a POC with 3 comments and a threshold for comments of 50 comments may have a comments metric value of 0.06. In another embodiment, a POC with 25 comments and a threshold for comments of 50 comments may have a comments metric value of 0.50. In yet another embodiment, a POC with 50+ comments and a threshold for comments of 50 comments may have a comments metric value of 1.00.

The downloads metric may be a normalized value which may measure the number of downloads for a POC. A threshold for downloads may be set to a predetermined value such as, for example, 10. That is, a POC with 10 downloads may receive the same metric value as a POC with 100 downloads. To calculate the downloads metric value for a POC, take a number of downloads divided by 10 and cap the value at 1. In an embodiment, a POC with 3 downloads and a threshold for downloads of 10 downloads may have a downloads metric value of 0.30. In another embodiment, a POC with 8 downloads and a threshold for downloads of 10 downloads may have a downloads metric value of 0.80. In yet another embodiment, a POC with 10+ downloads and a threshold for downloads of 10 downloads may have a downloads metric value of 1.00.

The bookmarks metric may be a normalized value which may measure the number of bookmarks for a POC. A threshold for bookmarks may be set to a predetermined value such as, for example, 5. That is, a POC with 5 bookmarks may receive the same metric value as a POC with 100 bookmarks. To calculate the bookmarks metric value for a POC, take a number of bookmarks divided by 5 and cap the value at 1. In an embodiment, a POC with 3 bookmarks and a threshold for bookmarks of 5 bookmarks may have a bookmarks metric value of 0.60. In another embodiment, a POC with 4 bookmarks and a threshold for bookmarks of 5 bookmarks may have a bookmarks metric value of 0.80. In yet another embodiment, a POC with 5+ bookmarks and a threshold for bookmarks of 5 bookmarks may have a bookmarks metric value of 1.00.

The featured metric may be a normalized value which may measure whether a POC is featured by a given online community or not. In a typical embodiment, this may be a constant metric with no threshold. That is, a POC that is featured may receive a featured metric value of 1.0 while a POC that is not featured may receive a featured metric value of 0.

The forum reply count metric may be a normalized value which may measure the number of forum replies for a POC. A threshold for forum replies may be set to a predetermined value such as, for example, 50. That is, a POC with 50 replies may receive the same metric value as a POC with 100 replies. To calculate the forum reply count metric value for a POC, take a number of forum replies divided by 50 and cap the value at 1. In an embodiment, a POC with 3 replies and a threshold for forum replies of 50 replies may have a forum reply count metric value of 0.06. In another embodiment, a POC with 25 replies and a threshold for forum replies of 50 replies may have a forum reply count metric value of 0.50. In yet another embodiment, a POC with 50+ replies and a threshold for forum replies of 50 replies may have a forum reply count metric value of 1.00.

The likes metric may be a normalized value which may measure the number of likes for a POC. A threshold for likes may be set to a predetermined value such as, for example, 100. That is, a POC with 100 likes may receive the same metric value as a POC with 200 likes. To calculate the likes metric value for a POC, take a number of likes divided by 100 and cap the value at 1. In an embodiment, a POC with 3 likes and a threshold for likes of 100 likes may have a likes metric value of 0.03. In another embodiment, a POC with 25 likes and a threshold for likes of 100 likes may have a likes metric value of 0.25. In yet another embodiment, a POC with 100+ likes and a threshold for likes of 100 likes may have a likes metric value of 1.00.

The ratings metric may be a normalized value which may measure the average rating for a POC. A minimum threshold for using the average rating may be set to a predetermined value such as, for example, 5. That is, a POC with less than 5 ratings may receive a constant metric value (essentially a 3-star rating) regardless of the actual average rating. Once there are at least 5 ratings, the metric value may be the average of all of the plurality of ratings for the POC divided by 5. In an embodiment, a POC with 0 ratings and a minimum threshold for using the average rating set to 5 may have a ratings metric value of 0.60. In another embodiment, a POC with 4 ratings of 1-star and a minimum threshold for using the average rating set to 5 may have a ratings metric value of 0.60. In yet another embodiment, a POC with 5+ratings of 4-star average and a minimum threshold for using the average rating set to 5 may have a ratings metric value of 0.80.

The suggested answer metric may be a normalized value which may measure whether a POC is a suggested answer or not. In a typical embodiment, this may be a constant metric with no threshold. That is, a POC that is marked as a suggested answer may receive a suggested answer metric value of 0.75 while a POC that is not marked as a suggested answer may receive a suggested answer metric value of 0.

The tags metric may be a normalized value which may measure the number of tags for a POC. A threshold for tags may be set to a predetermined value such as, for example, 5. That is, a POC with 5 tags may receive the same metric value as a POC with 10 tags. To calculate the tags metric value for a POC, take a number of tags divided by 5 and cap the value at 1. In an embodiment, a POC with 3 tags and a threshold for tags of 5 tags may have a tags metric value of 0.60. In another embodiment, a POC with 4 tags and a threshold for tags of 5 tags may have a tags metric value of 0.80. In yet another embodiment, a POC with 5+ tags and a threshold for tags of5 tags may have a tags metric value of 1.00.

The user subscriptions metric may be a normalized value which may measure the number of subscriptions for a POC. A threshold for subscriptions may be set to a predetermined value such as, for example, 25. That is, a POC with 25 subscriptions may receive the same metric value as a POC with 50 subscriptions. To calculate the user subscriptions metric value for a POC, take a number of subscriptions divided by 25 and cap the value at 1. In an embodiment, a POC with 3 subscriptions and a threshold for subscriptions of 25 subscriptions may have a user subscriptions metric value of 0.12. In another embodiment, a POC with 15 subscriptions and a threshold for subscriptions of 25 subscriptions may have a user subscriptions metric value of 0.60. In yet another embodiment, a POC with 25+ subscriptions and a threshold for subscriptions of 25 subscriptions may have a user subscriptions metric value of 1.00.

The verified answer metric may be a normalized value which may measure whether a POC is a verified answer or not. In a typical embodiment, this may be a constant metric with no threshold. That is, a POC that is marked as a verified answer may receive a verified answer metric value of 1.0 while a POC that is not marked as a verified answer may receive a verified answer metric value of 0.

The views metric may be a normalized value which may measure the number of views for a POC. A threshold for views may be set to a predetermined value such as, for example, 1000. That is, a POC with 1000 views may receive the same metric value as a POC with 2000 views. To calculate the views metric value for a POC, take a number of views divided by 1000 and cap the value at 1. In an embodiment, a POC with 3 views and a threshold for views of 1000 views may have a views metric value of 0.003. In another embodiment, a POC with 25 views and a threshold for views of 1000 views may have a views metric value of 0.025. In yet another embodiment, a POC with 1000+ views and a threshold for views of 1000 views may have a views metric value of 1.00.

In an example of an embodiment, a blog post may comprise 12 comments, 3 bookmarks, 16 likes,8 ratings (5, 4, 4, 5, 4, 4, 4, 2), 3 tags and 230 views. The blog post may further comprise a comments metric threshold of 50, a bookmarks metric threshold of 5, a likes metric threshold of 100, a minimum threshold for using the average rating of 5, a tags metric threshold of 5, and a views metric threshold of 1000. Using the calculations described hereinabove, the blog post has a comments metric value of 0.24, a downloads metric value of 0, a bookmarks metric value of 0.60, a featured metric value of 0, a forum reply count metric value of 0, a likes metric value of 0.16, a ratings metric value of 0.80, a suggested answer metric value of 0, a tags metric value of 0.60, a user subscription metric value of 0, a verified answer metric value of 0, and a views metric value of 0.22. A site associated with the blog post may comprise a decay value of 1.0 and a normal weighted value, for example, 0.50, for all the metrics except for tags which may be lowered to 0.25 and likes which may be raised to 0.75. The metrics' values may be multiplied by their weighted value. The metrics' values may then be added together and divided by the sum of the weighted values. The metrics' values may lastly be multiplied by the decay value. The calculation may result in a value of 0.2. As a result, the blog post may comprise a CQS, for example, of 0.2.

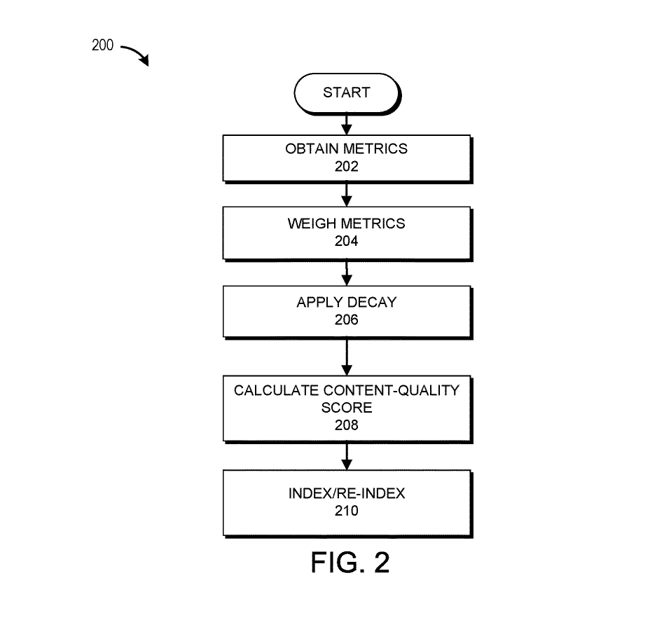

FIG. 2 illustrates an example of a process 200 for content-quality scoring. The process 200 can be triggered, for example, automatically for all or particular POCs stored on a given system, manually by an administrator, or in another suitable manner. The process 200 can be implemented by any system that can access one or more data sources. For example, the process 200, in whole or in part, can be implemented by one or more of the community computer system 102, the community computer system 102a, the collaboration server 108, the analytics server 112, the search server 122, the one or more collaboration databases 114, the one or more analytics databases 116, and/or the one or more content databases 120. The process 200 can also be performed generally by the system 100. Although any number of systems, in whole or in part, can implement the process 200, to simplify discussion, the process 200 will be described in relation to specific components of the community computer system 102a.

At block 202, the analytics server 112 obtains metrics associated with a POC. At block 204, the analytics server 112 weighs the plurality of metrics. In a typical embodiment, the weighing results in a weighted value for each of the plurality of metrics. At block 206, the analytics server 112 applies a decay to the weighed values. In a typical embodiment, the application of the decay results in a plurality of decayed values. At block 208, the analytics server calculates a CQS for the POC, for example, as described above. At block 210, the search server 122 indexes or re-indexes a plurality of POCs. The plurality of POCs include the POC for which a CQS was calculated at the block 208. The block 210 can include, for example, indexing/re-indexing the plurality of POCs based, at least in part, on a most recent CQS associated with each of the plurality of POCs.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A method for content-quality scoring, the method comprising, by a computer system comprising computer hardware:
obtaining a plurality of metrics associated with a piece of online content, wherein the piece of online content is obtained from a post of an online community;
calculating a content-quality score for the piece of content by at least:
weighing the plurality of metrics, the weighing yielding a plurality of weighted values, wherein the weighing includes multiplying the plurality of metrics by a plurality of predetermined weights;
calculating a first sum by adding together the plurality of weighted values;
calculating a second sum by adding together the plurality of predetermined weights;
calculating a quotient by dividing the first sum by the second sum; and
applying a decay value to the quotient to yield the content-quality score for the piece of content.

2. The method according to claim 1, wherein the plurality of metrics comprises at least one of a comments metric, a downloads metric, a bookmarks metric, a featured metric, a forum reply count metric, a likes metric, a ratings metric, a suggested answer metric, a tags metric, a user subscriptions metric, a verified answer metric, a views metric, and user custom metrics.

3. The method according to claim 1, wherein the plurality of metrics includes a comments metric, a bookmarks metric, a likes metric, a tags metric, and a views metric.

4. The method according to claim 1, wherein the decay value comprises a half-life calculation at a completion of an interval of time, wherein the decay value is 1 at a first time, and wherein the decay value is 0.5 at a second time..

5. The method according to claim 4, wherein the decay value is 0.25 at a third time.

6. The method according to claim 4, wherein the interval of time is thirty days.

7. The method according to claim 1 further comprising indexing a plurality of pieces of content so as to return a piece of content with a higher content-quality score before a piece of content with a lower content-quality score during a search of the plurality of pieces of content.

8. The method according to claim 7 further comprising re-indexing the plurality of pieces of content when a content-quality score is recalculated for at least one of the plurality of pieces of content.

9. A system comprising:
at least one processing unit, wherein the at least one processing unit is operable to implement a method comprising:
obtaining a plurality of metrics associated with a piece of online content, wherein the piece of online content is obtained from a post of an online community;
calculating a content-quality score for the piece of content by at least:
weighing the plurality of metrics, the weighing yielding a plurality of weighted values, wherein the weighing includes multiplying the plurality of metrics by a plurality of predetermined weights;
calculating a first sum by adding together the plurality of weighted values;
calculating a second sum by adding together the plurality of predetermined weights;
calculating a quotient by dividing the first sum by the second sum; and
applying a decay value to the quotient to yield the content-quality score for the piece of content.

10. The system according to claim 9 wherein the plurality of metrics comprises at least one of a comments metric, a downloads metric, a bookmarks metric, a featured metric, a forum reply count metric, a likes metric, a ratings metric, a suggested answer metric, a tags metric, a user subscriptions metric, a verified answer metric, a views metric, and user custom metrics.

11. The system according to claim 9, wherein the plurality of metrics includes a comments metric, a bookmarks metric, a likes metric, a tags metric, and a views metric.

12. The system according to claim 9, wherein the decay value comprises a half-life calculation at a completion of an interval of time, wherein the decay value is 1 at a first time, and wherein the decay value is 0.5 at a second time.

13. The system according to claim 12, wherein the decay value is 0.25 at a third time.

14. The system according to claim 12, wherein the interval of time is thirty days.

15. The system according to claim 9, wherein the method further comprises indexing a plurality of pieces of content so as to return a piece of content with a higher content-quality score before a piece of content with a lower content-quality score during a search of the plurality of pieces of content.

16. The system according to claim 15, wherein the method further includes re-indexing the plurality of pieces of content when a content-quality score is recalculated for at least one of the plurality of pieces of content.

17. A computer-program product comprising a non-transitory computer-usable medium having computer-readable program code embodied therein, the computer-readable program code adapted to be executed to implement a method comprising:
obtaining a plurality of metrics associated with a piece of online content, wherein the piece of online content is obtained from a post of an online community;
calculating a content-quality score for the piece of content by at least:
weighing the plurality of metrics, the weighing yielding a plurality of weighted values, wherein the weighing includes multiplying the plurality of metrics by a plurality of predetermined weights;
calculating a first sum by adding together the plurality of weighted values;
calculating a second sum by adding together the plurality of predetermined weights;
calculating a quotient by dividing the first sum by the second sum; and
applying a decay value to the quotient to yield the content-quality score for the piece of content.

18. The computer-program product according to claim 17, wherein the plurality of metrics comprises at least one of a comments metric, a downloads metric, a bookmarks metric, a featured metric, a forum reply count metric, a likes metric, a ratings metric, a suggested answer metric, a tags metric, a user subscriptions metric, a verified answer metric, a views metric, and user custom metrics.

19. The computer-program product according to claim 17, wherein the plurality of metrics includes a comments metric, a bookmarks metric, a likes metric, a tags metric, and a views metric.

20. The computer-program product according to claim 17, wherein the decay value comprises a half-life calculation at a completion of an interval of time, wherein the decay value is 1 at a first time, and wherein the decay value is 0.5 at a second time.
